(19) United States
(12) Patent Application Publication
(10) Pub. No.: US 2009/0046649 A1
(43) Pub. Date: Feb. 19, 2009

(54) Mapping of uplink ACK in TDD with asymmetric frame structure

(75) Inventors: Chun Yan Gao, Beijing (CN); Yuan Zhu, Beijing (CN); Xiangguang Che, Beijing (CN)

Correspondence Address: HARRINGTON & SMITH, PC, 4 RESEARCH DRIVE, Suite 202, SHELTON, CT, 06484-6212, US

(73) Assignee: Nokia Corporation

(21) Appl. No.: 12/228,451

(22) Filed: Aug. 12, 2008

Related U.S. Application Data
(60) Provisional application No. 60/964,633, filed on Aug. 13, 2007.

(51) Int. Cl. H04W 60/00

(52) U.S. Cl. 370/329

(57) ABSTRACT

For each of at least two ratios of downlink subframes exceeding uplink subframes in a frame is stored a pre-determined grouping of a plurality of downlink subframes that map to one uplink subframe. A frame is scheduled corresponding to one of the ratios. Scheduling grants are transmitted to user equipments UEs in at least some of the scheduled downlink subframes, wherein the number of scheduled downlink subframes is greater than the number of scheduled uplink subframes in the frame. The UEs receive their grant, map the downlink subframe in which the scheduling grant was received to an uplink subframe using the stored predetermined grouping for the ratio that corresponds to the frame in which the scheduling grant was received, and send their ACK/NACK for the grant in the mapped subframe. The network receives multiple ACKs/NACKs in a single uplink subframe and maps them, to the downlink subframes of the group.

### CROSS REFERENCE TO RELATED APPLICATION

This application claims priority under 35 USC 119(e) to U.S. Provisional Patent Application No. 60/964,633, filed Aug. 13, 2008. The contents of that priority document are hereby incorporated in its entirely, including exhibit A that was attached thereto.

### TECHNICAL FIELD

The teachings herein relate generally to wireless networks that allocate uplink and downlink resources to mobile/user equipment, and particularly relate to associating acknowledgement messages or lack thereof to a particular radio resource/subframe granted to a mobile/user equipment by the network when there are multiple resource granted in a frame.

### BACKGROUND

The following abbreviations and terms are herewith defined:

3GPP third generation partnership project

ACK acknowledgement message or bit(s)

CCFI control channel format indicator (also termed Cat0 bits)

DL downlink

Node B base station, or evolved node B of an LTE system

E-UTRAN evolved UTRAN

FDD frequency division duplex

HARQ hybrid automatic repeat request

LTE long term evolution of 3GPP, (also E-UTRAN or 3.9G)

MME mobility management entity

NAK or NACK negative ACK or lack of an ACK within a prescribed time period

Node B base station or similar network access node

OFDM orthogonal frequency division multiplex

PDCCH packet data control channel

PRB physical resource block

RNC radio network controller

TDD time division duplex

TTI transmission time interval

UE user equipment (e.g., mobile equipment/station)

UL uplink

UTRAN UMTS terrestrial radio access network

VOI voice over IP

3GPP is standardizing the long-term evolution (LTE) of the radio-access technology which aims to achieve reduced latency, higher user data rates, improved system capacity and coverage, and reduced cost for the operator. The current understanding of LTE relevant to these teachings may be seen at 3GPP TR 25.814 (v7.1.0, 2006-09) entitled PHYSICAL LAYER ASPECTS OF EVOLVED UTRA and herein incorporated by reference. Both FDD and TDD are considered in LTE for different operation modes. Due to their difference in frame structure and duplex mode, some designs for FDD and TDD can be different (see section 6.2 et seq. of TR 25.814). As summarized at Sections 7.1.1.2.3.2 and 7.1.1.2.3.3 of that document, an uplink scheduling grant indicates an identifier for the UE or UE group to which the subframe is being granted, and a hybrid ACK is used (up to one bit per transport block) for the allocated UE to respond with an ACK/NAK bit.

Some general principles of scheduling in E-UTRAN are recited at section 7.2.1 of TR 25.814. The Node B scheduler dynamically controls which time/frequency resources are allocated to a certain UEs at a given time. Downlink control signaling informs UE(s) what resources and respective transmission formats have been allocated. The scheduler can instantaneously choose the best multiplexing strategy from the available methods; e.g. frequency localized or frequency distributed transmission. The flexibility in selecting resource blocks and multiplexing UEs will influence the available scheduling performance. Scheduling is tightly integrated with link adaptation and hybrid automatic repeat request HARQ.

In FDD, it has been agreed that there are at most 3 OFDM symbols in each TTI that are reserved for control signaling on the PDCCH. Consider for this description that a TTI as applied to LTE is one subframe. Those 3 OFDM symbols are to include DL and UL scheduling grants as well as CCFI/Cat0 information that gives the format of the control channel. The CCFI/Cat0 is length 2 bits and indicates how many OFDM symbols are used for control.

There has been some interest in developing LTE as to how exactly to map the UL resources that are allocated to a UE to the scheduling grant sent on a DL control channel (the PDCCH in LTE) that grants to the UE those UL resources. Because the control channel is a common channel to which multiple UE listen for their respective grants, much control signaling overhead may be saved by having some mapping from the scheduling grant itself to the radio resources being granted to the UE. Some proposals advance an implicit mapping and others advance explicit signaling of the mapping. For example and in the TDD operation mode, both network and UE may recognize an implicit mapping whereby a UL scheduling grant received in the ith DL sub-frame is mapped to the ith UL sub-frame. This one-to-one correspondence is valid where the number of UL subframes being allocated in a frame is no greater than the number of DL subframes in which the scheduling grants may be sent in that frame, DL≦UL in shorthand. Other more involved mapping schemes, either implicit, explicit, or hybrid, have been proposed for the more difficult instances where DL<UL. To give the network greater flexibility in allocating those UL resources as the UE's needs for radio resources change, the network is able to dynamically adjust the DL to UL ratio in any given frame of the PDCCH.

However the mapping may be done for the DL<UL scenario, a related problem arises in how the UEs receiving data transmissions on the scheduled DL subframes send their acknowledgements that they've received the data. In a HARQ scheme generally the UE sends an ACK message (as little as one bit) to confirm receipt of the DL data and the network recognizes that the absence of such an ACK message within a certain time constraint is a NAK, indicating the UE did not receive the transmitted data. Some systems have the UE send a NAK bit to positively indicate that expected data was not received (or was not properly decoded).

For FDD, since the DL and UL are symmetric (DL=UL), each DL transmission in one DL subframe will be responded by an ACK/NAK in a known UL subframe with a certain delay. For multiple UEs transmitting in the same DL subframe, it is agreed as seen in a paper entitled: DRAFT REPORT OF 3GPP TSG RAN WG1 #49B v0.3.0; MCC Support; Orlando, Fla., 25-29 Jun. 2007; section 7.13.2 at page 42 [Exhibit A of the U.S. priority document 60/964,633] that “for non-persistent scheduling the ACK/NAK resource is linked to the index of the control channel used for scheduling”. In the case of FDD operation then, there is one to one mapping between UL subframe for ACK/NAK transmission and DL subframe for data transmission.

For non-persistently scheduled UEs transmitting in the same DL TTI in FDD, their ACK/NAKs are sent in the same UL TTI with certain delay relative to the DL TTI, and the exact ACK/NACK resource in that UL TTI is implicitly linked to their indexes of the control channel in the DL TTI [for LTE, the TTI represents one subframe]. In the case of TDD operation for both frame structure types 1 and 2, when the number of DL subframes is more than the number of UL subframes (DL>UL), the direct implicit mapping cannot apply any more. In such a case, there is the need to send ACK/NAK for multiple DL subframes in one UL subframe.

This problem is exemplified in FIG. 1, which illustrates two consecutive frames A and B in which DL>UL in each of those frames. DL subframes are darkened and accorded reference numbers 101A, 102A, 103A, 104A and 105A in the first frame A, and reference numbers 101B, 102B, 103B, 104B and 105B in the second frame B. Uplink resources over which the UE sends its ACK are the lightened subframes and accorded reference numbers 110A and 111A in the first frame A and 110B and 111B in the second frame B. Now the ACK messages 120, 121 sent by the UE in the second frame B are meant to acknowledge the sending UE's receipt of the data sent in a previous DL subframe, which in FIG. 1 could be DL subframes 102A, 103A, 104A, 015A or 101B. But since there are five DL subframes and only two UL subframes available in which to send ACK messages for the five DL subframes, the implicit mapping of UL subframe to DL subframe can no longer be used by the network to determine exactly which of the ACKs the UEs send in subframes 110B and 111B apply to which of the DL subframes 102A 103A, 104A, 105A or 101B. The implicit mapping noted in the above-cited DRAFT REPORT OF 3GPP TSG RAN WG1 #49B V0.3.0 only works when DL≦UL.

What is needed in the art is a way to map ACK massages (and therefore also the timing of NAK) for a UL subframe to a DL subframe being ACKed when the network partitions the frame as DL>UL.

### SUMMARY

In accordance with one exemplary embodiment of the invention is a method that includes storing a pre-determined grouping of a plurality of downlink subframes that map to one uplink subframe for each of at least two instances of a ratio of number of downlink subframes exceeding number of uplink subframes in a frame; scheduling a series of downlink and uplink subframes in a frame corresponding to one of the ratios and sending scheduling grants to user equipments in at least some of the scheduled downlink subframes, wherein the number of scheduled downlink subframes is greater than the number of scheduled uplink subframes in the frame; receiving acknowledgements from the user equipments to which the scheduling grants were sent, wherein multiple ones of the acknowledgements are received in a single uplink subframe; and mapping all of the multiple acknowledgements received in the single uplink subframe to the downlink subframes of the group that maps to the single uplink subframe according to the predetermined grouping for the corresponding ratio.

In accordance with another exemplary embodiment of the invention is a memory embodying a program of machine readable instructions executable by a processor to perform actions directed to mapping acknowledgement messages. In this embodiment the actions include storing a pre-determined grouping of a plurality of downlink subframes that map to one uplink subframe for each of at least two instances of a ratio of number of downlink subframes exceeding number of uplink subframes in a frame; scheduling a series of downlink and uplink subframes in a frame corresponding to one of the ratios and sending scheduling grants to user equipments in at least some of the scheduled downlink subframes, wherein the number of scheduled downlink subframes is greater than the number of scheduled uplink subframes in the frame; receiving acknowledgements from the user equipments to which the scheduling grants were sent, wherein multiple ones of the acknowledgements are received in a single uplink subframe; and mapping all of the multiple acknowledgements received in the single uplink subframe to the downlink subframes of the group that maps to the single uplink subframe according to the predetermined grouping for the corresponding ratio.

In accordance with still another exemplary embodiment of the invention is an apparatus that includes a memory, a scheduler, a transmitter, a receiver and a processor. The memory stores a pre-determined grouping of a plurality of downlink subframes that map to one uplink subframe for each of at least two instances of a ratio of number of downlink subframes exceeding number of uplink subframes in a frame. The scheduler is configured to schedule a series of downlink and uplink subframes in a frame corresponding to one of the ratios, wherein the number of scheduled downlink subframes is greater than the number of scheduled uplink subframes in the frame. The transmitter is configured to send scheduling grants to user equipments in at least some of the scheduled downlink subframes. The receiver is configured to receive acknowledgements from the user equipments to which the scheduling grants were sent, wherein multiple ones of the acknowledgements are received in a single uplink subframe. And the processor is configured to map all of the multiple acknowledgements received in the single uplink subframe to the downlink subframes of the group that maps to the single uplink subframe according to the predetermined grouping for the corresponding ratio.

In accordance with still another exemplary embodiment of the invention is a method that includes storing a pre-determined grouping of a plurality of downlink subframes that map to one uplink subframe for each of at least two instances of a ratio of number of downlink subframes exceeding number of uplink subframes in a frame; receiving a scheduling grant in a downlink subframe of a frame for which the number of scheduled downlink subframes is greater than the number of scheduled uplink subframes in the frame; using the stored predetermined grouping for the ratio that corresponds to the frame in which the scheduling grant was received to map the downlink subframe in which the scheduling grant was received to an uplink subframe; and sending in the mapped uplink subframe an acknowledgement for the received scheduling grant.

In accordance with still another exemplary embodiment of the invention is a memory embodying a program of machine readable instructions executable by a processor to perform actions directed to mapping a scheduling grant. In this embodiment the actions include storing a pre-determined grouping of a plurality of downlink subframes that map to one uplink subframe for each of at least two instances of a ratio of number of downlink subframes exceeding number of uplink subframes in a frame; receiving a scheduling grant in a downlink subframe of a frame for which the number of scheduled downlink subframes is greater than the number of scheduled uplink subframes in the frame; using the stored predetermined grouping for the ratio that corresponds to the frame in which the scheduling grant was received to map the downlink subframe in which the scheduling grant was received to an uplink subframe; and sending in the mapped uplink subframe an acknowledgement for the received scheduling grant.

In accordance with still another exemplary embodiment of the invention is an apparatus that includes a memory, a receiver, a processor and a transmitter. The memory stores a pre-determined grouping of a plurality of downlink subframes that map to one uplink subframe for each of at least two instances of a ratio of number of downlink subframes exceeding number of uplink subframes in a frame. The receiver is configured to receive a scheduling grant in a downlink subframe of a frame for which the number of scheduled downlink subframes is greater than the number of scheduled uplink subframes in the frame. The processor is configured to use the stored predetermined grouping for the ratio that corresponds to the frame in which the scheduling grant was received to map the downlink subframe in which the scheduling grant was received to an uplink subframe. The transmitter is configured to send in the mapped uplink subframe an acknowledgement for the received scheduling grant.

These and other aspects are detailed with particularity below.

### BRIEF DESCRIPTION OF THE DRAWINGS

The foregoing and other aspects of these teachings are made more evident in the following Detailed Description when read in conjunction with the attached Drawing Figures.

FIG. 1 is a schematic diagram of a prior art TDD frame structure illustrating a problem of a UL ACK transmission in TDD with more DL subframes than UL subframes.

FIG. 2 shows a simplified block diagram of various electronic devices that are suitable for use in practicing the exemplary embodiments of this invention.

FIG. 3 is similar to FIG. 1 but showing grouping DL subframes into N=5 groups that map to five physical resource blocks for ACK/NACK.

FIG. 4A is similar to FIG. 3 but showing N=2 groups that map to two physical resource blocks, one in each of two UL subframes.

FIG. 4B is similar to FIG. 4A but showing N=4 groups that map to four physical resource blocks for ACK/NACK, two in each of two UL subframes.

FIG. 5 is similar to FIG. 4A but where mapping is implicit by how the control signaling is arranged.

FIGS. 6 and 7 respectively modify FIGS. 4A and 5 for a larger processing delay.

FIGS. 8 and 9 illustrate process flow diagrams for various aspects of the invention.

### DETAILED DESCRIPTION

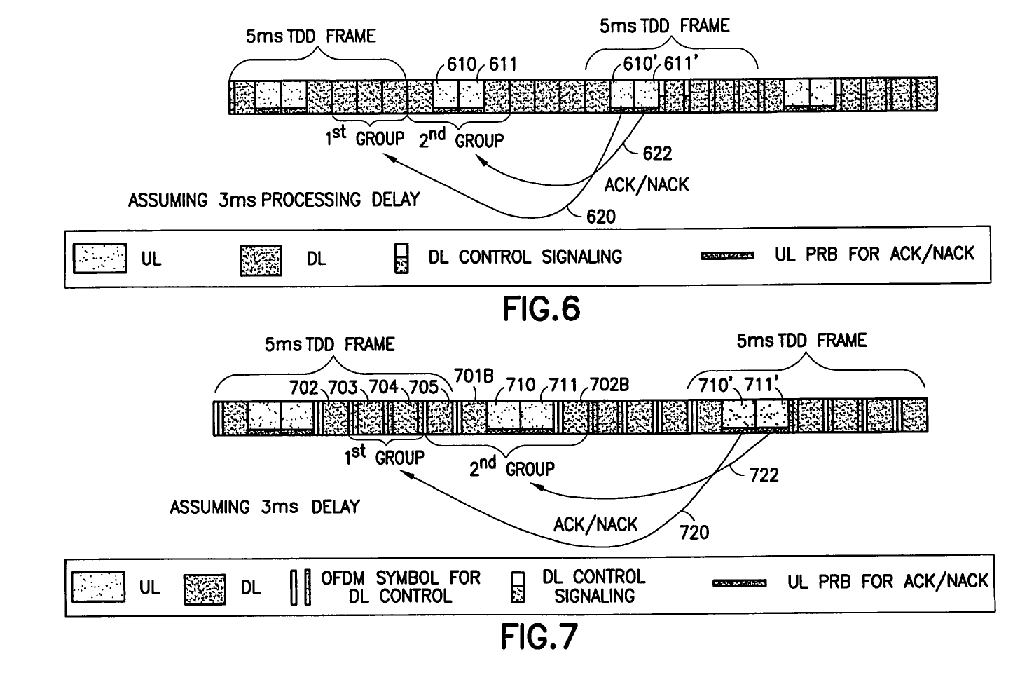

The problem detailed above may be stated as how to send ACKs for multiple DL subframes in one UL subframe. In that respect the problem becomes how to map multiple ACK PRBs sent in one UL subframe to individual DL subframes being ACKed. Examples of the solution are detailed below with respect to FIGS. 3-5 and some variation for large processing delay given at FIGS. 6-7. In general, the approach is to divide the DL subframes into N groups, where N is the number of UL PRBs for ACK/NAK. The ACK for the ith group is sent through the ith UL ACK PRB. For UEs in the same DL group, their UL ACK/NACK resource is implicitly determined by the control channel index in this DL group or explicitly signaled. Three methods for the DL grouping are detailed below.

While the description below is in the context of LTE, the breadth of the invention is not limited only to that wireless protocol and may be practiced, for example, in any network in which a frame or other radio resource entity can be divided unequally as to DL and UL resources, and where at least some of the DL resources must be mapped to the UL resources. For example, GSM (global system for mobile communications) or UMTS (universal mobile telecommunications system) may be adapted for such an asymmetric DUUL split. More generic terms are introduced to avoid the implication that the use of terms specific to LTE in the examples below limit the invention to LTE: a DL or UL radio resource represents what in LTE is a DL or UL subframe and is a discrete unit of DL or UL radio resources. A PRB is a limited portion of the radio resource set aside for an ACK resource. So in LTE, the ACK PRB is only a limited portion of the UL subframe that the network grants to a UE; the UE can send an ACK PRB and user data on the same UL radio resource that the network granted it. It is only exemplary that the below description uses terms such as subframe and PRB that are commonly associated with LTE.

Reference is now made to FIG. 2 for illustrating a simplified block diagram of various electronic devices that are suitable for use in practicing the exemplary embodiments of this invention as detailed above. In FIG. 2 a wireless network 9 is adapted for communication between a UE 10 and a Node B 12 (e-Node B). The network 9 may include a gateway GW/serving mobility entity MME/radio network controller RNC 14 or other radio controller function known by various terms in different wireless communication systems. The UE 10 includes a data processor (DP) 10A, a memory (MEM) 10B that stores a program (PROG) 10C, and a suitable radio frequency (RF) transceiver 10D coupled to one or more antennas 10E (one shown) for bidirectional wireless communications over one or more wireless links 20 with the Node B 12.

The Node B 12 also includes a DP 12A, a MEM 12B, that stores a PROG 12C, and a suitable RF transceiver 12D coupled to one or more antennas 12E. The Node B 12 may be coupled via a data path 30 (e.g., lub or S1 interface) to the serving or other GW/MME/RNC 14. The GW/MME/RNC 14 includes a DP 14A, a MEM 14B that stores a PROG 14C, and a suitable modem and/or transceiver (not shown) for communication with the Node B 12 over the lub link 30.

Also within the node B 12 is a scheduler 12F that schedule the various UEs under its control for the various UL and DL radio resources or subframes. Once scheduled, the Node B sends messages to the UEs with the scheduling grants (typically multiplexing grants for multiple UEs in one message). These grants are sent over the particular channels noted with the specific embodiments detailed above. Generally, the Node B 12 of an LTE system is fairly autonomous in its scheduling and need not coordinate with the GW/MME 14 excepting during handover of one of its UEs to another Node B. The scheduler 12F allocates and tracks which UEs are scheduled to send on the various granted UL radio resources and to receive on the various scheduled DL resources.

At least one of the PROGs 10C, 12C and 14C is assumed to include program instructions that, when executed by the associated DP, enable the electronic device to operate in accordance with the exemplary embodiments of this invention, as detailed above. Inherent in the DPs 10A, 12A, and 214A is a clock to enable synchronism among the various apparatus for transmissions and receptions within the appropriate time intervals and slots required, as the scheduling grants, the radio resources being scheduled, and the ACKs/NAKs are time dependent.

The PROGs 10C, 12C, 14C may be embodied in software, firmware and/or hardware, as is appropriate. In general, the exemplary embodiments of this invention may be implemented by computer software stored in the MEM 10B and executable by the DP 10A of the UE 10 and similar for the other MEM 12B and DP 12A of the Node B 12, or by hardware, or by a combination of software and/or firmware and hardware in any or all of the devices shown.

In general, the various embodiments of the UE 10 can include, but are not limited to, mobile stations, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The MEMs 10B, 12B and 14B may be of any type suitable to the local technical environment and may be implemented using any suitable data storage technology, such as semiconductor-based memory devices, magnetic memory devices and systems, optical memory devices and systems, fixed memory and removable memory. The DPs 10A, 12A and 14A may be of any type suitable to the local technical environment, and may include one or more of general purpose computers, special purpose computers, microprocessors, digital signal processors (DSPs) and processors based on a multi-core processor architecture, as non-limiting examples.

As noted above, according to embodiments of this invention ACKs for multiple DL subframes are sent in one UL subframe, at least when there are more DL subframes than UL subframes in a frame of a TDD frame structure, by dividing the DL subframes into N groups. The value of the integer N is equal to the number of UL PRBs set aside for ACKs/NAKs. Note that sometimes an ACK may not be used, such as where there is explicit channel quality indications CQI sent and the quality is seen to be sufficient that the UE will not be required to send an ACK and the network will not expect one. The below discussion presumes for simplicity that there will be an ACK expected for each DL subframe, and that the network does not dynamically change the DL:UL ratio in the two consecutive frames detailed.

There being N groups of DL subframes, the N ACK PRBs may then be indexed to the N groups of DL subframes. The ACK for the ith DL group is sent through the ith UL ACK PRB. For UEs in the same DL group, their UL ACK/NACK resource is implicitly determined by the control channel index in this DL group or explicitly signaled.

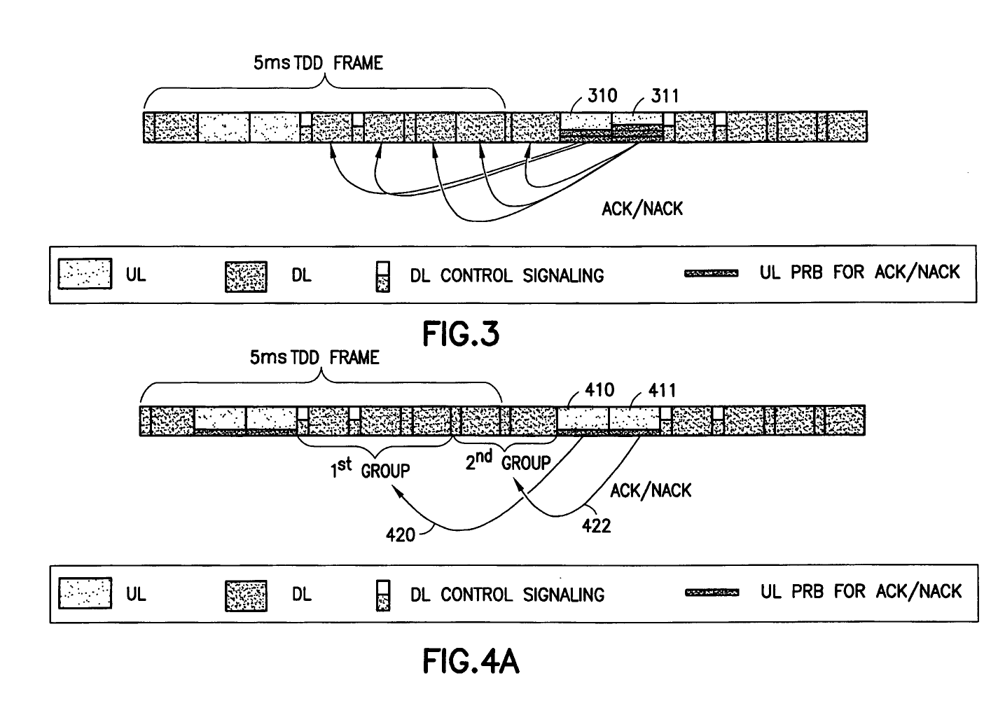

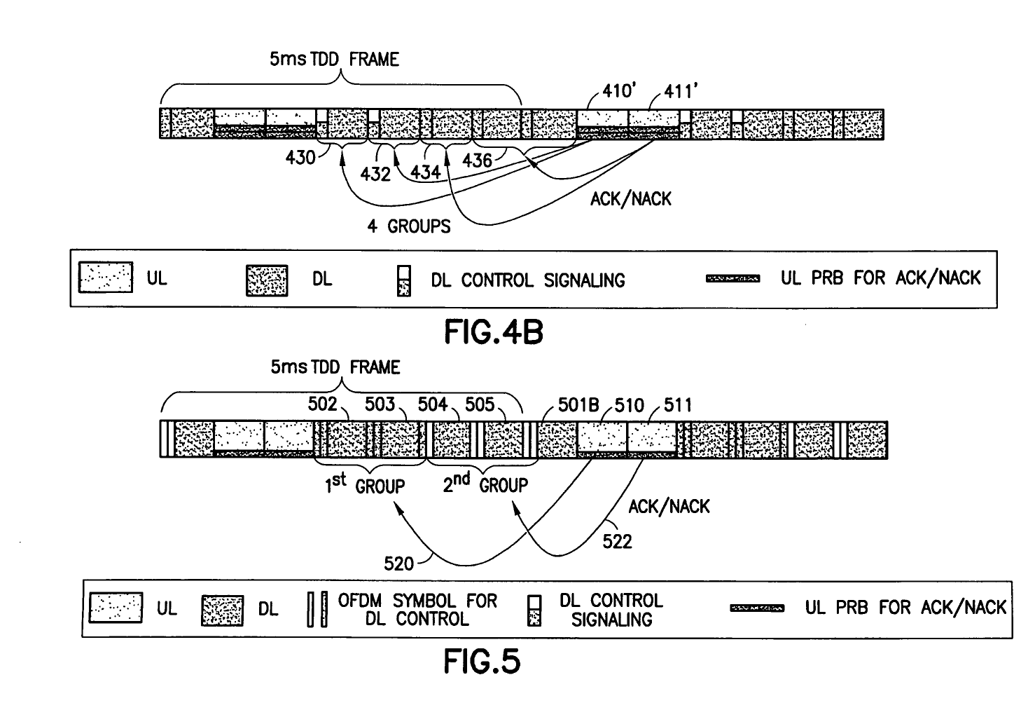

Three ways to do this DL grouping are detailed below, briefly summarized here. In a first embodiment, the DL is divided into units of subframes. So for example if the frame were partitioned with 5 DL subframes and 2 UL subframes, and 2PRBs reserved for ACK/NACK transmission, then an example of the DL grouping is to divide the 5 DL subframes into 2 groups as in FIG. 4A: a first group of three DL subframes and a second group of two subframes.

In a second embodiment, the DL subframes are divided according to DL control signaling resource. So for example if the split in a frame is again 5 DL subframes and 2 UL subframes, and 2 UL PRBs reserved for ACK/NAK transmission. Assuming two OFDM symbols are used for DL control in each DL subframe, then totally 10 OFDM symbols occupied for DL control signaling. UEs scheduled in the first 5 OFDM symbols for control will send their ACKs or NAKs in the first ACK PRB. In this example UEs are divided into 2 groups by control signaling division rather than straight DL subframes.

In a third embodiment there is flexible grouping of DL subframes. The division indication in sent in the first DL subframe or sent via upper layer signaling. The first and second embodiments need no additional control signaling but consequently there is a limit on just how flexible the network can be in its DL scheduling. The third embodiment is more flexible, but additional signaling is required to notify the UEs of the grouping of DL subframes.

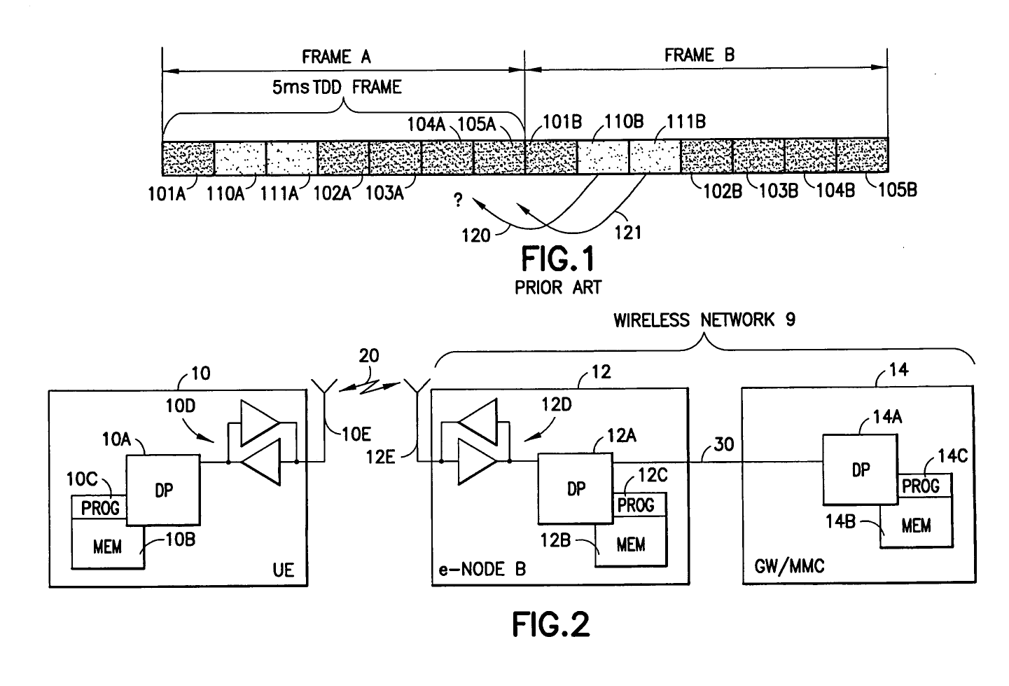

Now are detailed examples of the various embodiments for dividing the DL subframes into N groups. The legend of FIG. 3 applies also to FIGS. 4A-7. FIG. 3 illustrates two consecutive TDD frames of type FS2 similar to FIG. 1, each with 5DL subframes and 2UL subframes. There are respectively three and two PRBs reserved for ACK/NAK in the two UL subframes 310, 311. Then there are a total of five UL ACK/NAK PRBs reserved. Then the DL subframes are divided into N=5 groups according to the first embodiment. Each DL subframe is in one group, and there is one to one mapping. Each ACK PRB maps to one of the DL subframe groups, which in this first embodiment particularly shown at FIG. 3 means a mapping of each ACK PRB to one DL subframe.

FIG. 4A is the TDD of type FS2 with five DL subframes and two UL subframes in a frame, and one PRB is reserved for ACK/NAK in each of the two UL subframe. Using another implementation of the first embodiment to group the DL subframes as subframes, the first three DL subframes are put into a first group 420 and the last two DL subframes are put into the second group 422. Then the ACK/NAK for the first group 420 of DL subframes is sent in the first UL subframe 410, while the ACK/NAK for the second group of DL subframes is sent in the second UL subframe 422.

FIG. 4B illustrates another example of TDD of type FS2 with five DL subframes and two UL subframes in a frame. Here two PRBs are reserved for ACK/NACK in each of the two UL subframes 410′, 411′. Then a total of four PRBs are available for ACK/NAK are available. In this example, the DL subframes are divided into N=4 groups, shown in FIG. 4B as groups 430, 432, 434 and 436. The ACK/NACK for the ith group is sent in the ith UL ACK/NAK PRB.

FIG. 5 illustrates an example of the second embodiment, grouping by control signaling resource. For TDD with five DL subframes and two UL subframes, and assuming two OFDM symbols are reserved for DL control in each of the DL subframes 502, 503, 504, 505 and 501B, there are a total of ten OFDM symbols reserved for DL control signaling. Each of the UL subframes 510, 511 have only one ACK PRB as shown, so there are N=2 ACK PRBs and N=2 DL groups The UEs scheduled in the first five OFDM symbols (those of DL subframes 502, 503 and the first OFDM DL control symbol of DL subframe 504) are put into a first group 520 and will send their ACKs in the first UL subframe 510. The UEs scheduled in the last five OFDM symbols (the second OFDM DL control symbol of DL subframe 504 and the two OFDM DL control symbols in each of DL subframes 505 and 501B) are put into the second group 522 and will send their ACK in the second UL subframe 511.

In the above examples, assumed was a processing delay of 1 subframe. For the case of a larger processing delay, the grouping approach still applies, but the grouping result will be different. FIGS. 6 and 7 are examples with a processing delay of 3 ms. FIG. 6 modifies FIG. 4A for a 3 ms processing delay and FIG. 7 modifies FIG. 5 for a 3 ms processing delay.

Specifically, at FIG. 6 is seen the same arrangement of DL to UL subframes as in FIG. 4A, but because of the 3 ms processing delay the UEs are unable to send or not send an ACK in the two UL subframes 610, 611 immediately following the DL subframes of FIG. 4A, which in FIG. 6 are subframes 610 and 611. Instead the ACK PRBs are delayed until the next subsequent frame, UL subframes 610′ and 611′. The grouping of DL subframes to which these ACK PRBs map to also changes somewhat as compared to FIG. 4A, in that each of the DL subframe groupings are shifted rightward one DL subframe as compared to FIG. 4A.

At FIG. 7 is seen the same arrangement of DL to UL subframes as in FIG. 5, however due to the 3 ms processing delay at the UEs they cannot send an ACK in the first two UL subframes 710, 711 immediately following the original grouping shown in FIG. 4A. So the ACK is delayed until the following two UL subframes 710′, 711′ in the next frame subsequent to that used in FIG. 4A. Also, the grouping changes slightly: the first group 720 with this 3 ms processing delay now includes DL subframes 703, 704, 705 701B and 702B, and the corresponding OFM symbols are shifted by one DL subframe as compared to FIG. 5.

For the third embodiment using explicit signaling of the DL subframe groupings to the UEs, a commensurate time shift to compensate for a higher processing delay would result similarly in the signaled groups of DL subframes being spaced in time further from the ACK PRBs that map to those groups by the explicit signaling. As with FIGS. 6-7, the groupings of specific DL subframes may also shift by a DL subframe or two but the concept remains unchanged.

Grouping the DL subframes and mapping an ACK PRB to each of the groups offers several advantages. It solves the problem of sending ACK/NAKs for multiple DL subframes in one UL subframe. It gives flexibility to the Node B to allocate multiple ACK/NACK PRBs in one UL subframe, and thus gives more flexibility to DL scheduling at the Node B. And further it enables the balance of ACK/NACK load in each UL subframe. See for example FIGS. 3 and 4B, where multiple ACK PRBs are distributed evenly (within one PRB) among two UL subframes).

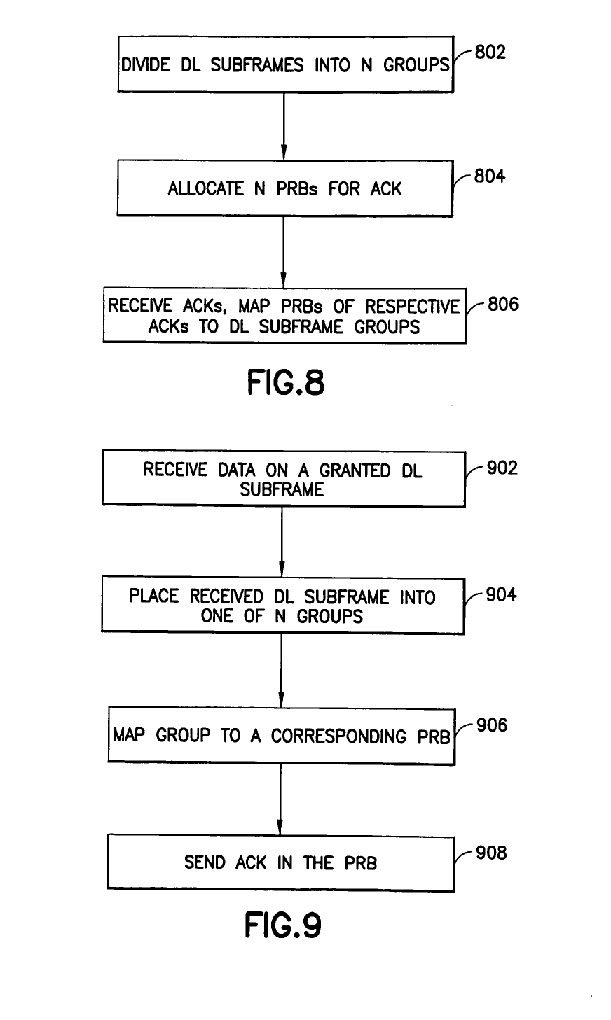

FIG. 8 is a process flow diagram representing process steps according to one aspect of the invention. At block 802 the DL subframes are divided into N groups, and N PRBs are allocated for ACK purposes. At block 804 a plurality of ACKs are received in a scheduled UL subframe, which absent a processing delay may be subframes scheduled in the DL subframes being ACKed. At block 806 the PRB of the received ACK is mapped to one of the N groups. For the first and second embodiments above, the mapping is implicit, and stored in a memory of the Node B without being signaled over the DL control channel that carries the scheduling grants for the UL subframes in which the ACKs are received. The grouping may be by DL subframes, or may be by UE's allocated in selected symbols of the DL subframes. In another embodiment the mapping is explicit in that the grouping of DL subframes is explicitly signaled to the UEs over the DL control channel that carries the scheduling grants for the UL subframes in which the ACK is received.

According to an aspect of the invention then is a memory embodying a computer program, and a method, and an apparatus, each of which operate to schedule a series of DL and UL subframes and to transmit scheduling grants to UEs on at least some of the DL subframes, and to divide the DL subframes into N groups, to allocate N PRBs of the scheduled UL subframes for ACK messages, and upon receipt of ACK messages during the scheduled UL subframes, to map PRBs of the respective received ACK messages to individual ones of the N groups of DL subframes. A network node such as a Node B of a LTE network may practice this aspect of the invention.

FIG. 9 is a process flow diagram illustrating another aspect of the invention. At block 902 is received data on the granted DL subframe. At block 904 the DL subframe is placed into one of N groups. At block 906 the group in which the DL subframe is placed is mapped to a corresponding PRB of a scheduled UL subframe. At block 908 an ACK message is sent on the PRB. For the first and second embodiments above, the mapping is implicit, and stored in a memory of the UE without being signaled over the DL control channel that carries the scheduling grants for the received DL subframe. The grouping may be by DL subframes, or may be by the symbol of a DL subframe in which the DL scheduling grant was received. In another embodiment the mapping is explicit in that the grouping of DL subframes is explicitly received by the UE over the DL control channel that carries the scheduling grants for the received DL subframe and for the UL subframe in which the ACK is sent.

According to another aspect of the invention is a memory embodying a computer program, and a method, and an apparatus, each of which operate to receive data in a DL subframe, to place the received DL subframe into one of N groups, to map the DL subframe group to a PRB of a UL subframe allocated for ACK messages, and to send an ACK message in the mapped PRB. A UE in a LTE network may practice this aspect of the invention.

So in one particular aspect of the invention is a method that includes scheduling a series of downlink and uplink subframes in a frame such that the number of scheduled downlink subframes exceeds the number of uplink subframes; sending scheduling grants in at least some of the scheduled downlink subframes; dividing the downlink subframes into N groups, where N is an integer at least equal to 2 and at least one of the groups has more than one downlink subframe; receiving acknowledgement messages that acknowledge the scheduled downlink subframes; and mapping individual ones of the received acknowledgement messages to an individual one of the N groups according to the uplink subframe in which the individual acknowledgement was received.

More particularized implementations of the method immediately above may exhibit one or more of the following: there are N uplink subframes in the frame; the dividing is according to a ratio of downlink to uplink subframes in the frame in which the scheduling grants were sent; the method further includes allocating N physical resource blocks for the acknowledgement messages and where the mapping is characterized by, for the case where there are more than one downlink subframes in the group, mapping each of the individual acknowledgement messages to an individual one of the downlink subframes within the group according to which physical resource block of the uplink subframe the individual acknowledgement message was received. Further particularized implementations exhibit the dividing being according to a number of downlink symbols of the scheduled downlink subframes that are occupied by downlink control signaling; the additional step of sending in one of the scheduled downlink subframes an indication of how the downlink subframes are divided into the N groups. Such a method may be executed by a node B that schedules the series of downlink and uplink subframes in the frame according to a time division duplex mode of an evolved universal mobile telecommunications system terrestrial radio access network. A memory embodying a program of machine readable instructions executable by a processor to perform actions directed to mapping acknowledgement messages may also be considered an embodiment of this aspect of the invention, wherein the actions follow those detailed immediately above for the method.

In another particular aspect of the invention is an apparatus such as a node B that includes a scheduler, a transmitter, a processor and a receiver. The scheduler is configured to schedule a series of downlink and uplink subframes in a frame such that the number of scheduled downlink subframes exceeds the number of uplink subframes, the transmitter is configured to send scheduling grants in at least some of the scheduled downlink subframes, the processor is configured to divide the downlink subframes into N groups, where N is an integer at least equal to 2 and at least one of the groups has more than one downlink subframe, and the receiver is configured to receive acknowledgement messages that acknowledge the scheduled downlink subframes. In this embodiment the processor is further configured to map individual ones of the received acknowledgement messages to an individual one of the N groups according to the uplink subframe in which the individual acknowledgement was received.

More particularized implementations of the apparatus immediately above may exhibit one or more of the following: there are N uplink subframes in the frame; the processor is configured to divide the downlink subframes into N groups according to a ratio of downlink to uplink subframes in the frame in which the scheduling grants were sent; the processor is further configured to allocate N physical resource blocks for the acknowledgement messages and for the case where there are more than one downlink subframes in the group the processor is further configured to map each of the individual acknowledgement messages to an individual one of the downlink subframes within the group according to which physical resource block or symbol of the uplink subframe the individual acknowledgement message was received; the processor is configured to divide the downlink subframes into N groups according to a number of downlink symbols of the scheduled downlink subframes that are occupied by downlink control signaling; the transmitter is further configured to send, in one of the scheduled downlink subframes, an indication of how the downlink subframes are divided into the N groups. Such an apparatus may be implemented as a node B of an evolved universal mobile telecommunications system terrestrial radio access network and the scheduler is configured to schedule the series of downlink and uplink subframes in the frame according to a time division duplex mode.

In still another particular aspect of the invention is a method that includes receiving a scheduling grant in a downlink subframe of a frame in which the number of downlink subframes exceeds the number of uplink subframes; dividing the downlink subframes into N groups, where N is an integer at least equal to 2 and at least one of the groups has more than one downlink subframe; mapping the group in which the downlink subframe having the scheduling grant was received to an uplink subframe; and sending in the mapped uplink subframe an acknowledgement message that acknowledge the scheduling grant.

More particularized implementations of the method immediately above may exhibit one or more of the following: there are N uplink subframes in the frame; the dividing is according to a ratio of downlink to uplink subframes in the frame in which the scheduling grants were sent; the method further includes (for the case where there are more than one downlink subframe in the group that includes the downlink subframe having the scheduling grant) mapping the downlink subframe having the scheduling grant to an individual physical resource block of the mapped uplink subframe wherein sending the acknowledgement message is in the mapped physical resource block of the mapped uplink subframe; the dividing is according to a number of downlink symbols of the downlink subframes of the frame that are occupied by downlink control signaling; and the method further includes receiving in one of the downlink subframes of the frame an indication of how the downlink subframes are divided into the N groups. Such a method as detailed immediately above may be executed by a user equipment operating in of an evolved universal mobile telecommunications system terrestrial radio access network, and wherein the frame is according to a time division duplex mode. A memory embodying a program of machine readable instructions executable by a processor to perform actions directed to mapping a scheduling grant may also be considered an embodiment of this aspect of the invention, wherein the actions follow those detailed immediately above for the method.

In still another particular aspect of the invention is an apparatus such as a user equipment that includes a receiver, a processor and a transmitter. The receiver is configured to receive a scheduling grant in a downlink subframe of a frame in which the number of downlink subframes exceeds the number of uplink subframes. The processor is configured to divide the downlink subframes into N groups, where N is an integer at least equal to 2 and at least one of the groups has more than one downlink subframe, and configured to map the group in which the downlink subframe having the scheduling grant was received to an uplink subframe. The transmitter is configured to send in the mapped uplink subframe an acknowledgement message that acknowledge the scheduling grant.

More particularized implementations of the apparatus immediately above may exhibit one or more of the following: there are N uplink subframes in the frame; the dividing is according to a ratio of downlink to uplink subframes in the frame in which the scheduling grants were sent and the mapping is stored in a memory of the apparatus; for the case where there is more than one downlink subframe in the group that includes the downlink subframe having the scheduling grant the processor is further configured to map the downlink subframe having the scheduling grant to an individual physical resource block of the mapped uplink subframe and the transmitter is configured to send the acknowledgement message in the mapped physical resource block of the mapped uplink subframe; the processor is configured to divide the downlink subframes into N groups according to a number of downlink symbols of the downlink subframes of the frame that are occupied by downlink control signaling; and the receiver is configured to receive in one of the downlink subframes of the frame an indication of how the downlink subframes are divided into the N groups. Such an apparatus may be implemented as a user equipment operating in of an evolved universal mobile telecommunications system terrestrial radio access network wherein the frame is according to a time division duplex mode.

For the aspects of this invention related to the Node B or network side, embodiments of this invention may be implemented by computer software executable by a data processor of the Node B 12, such as the processor 12A shown, or by hardware, or by a combination of software and hardware. For the aspects of this invention related to the UE side, embodiments of this invention may be implemented by computer software executable by a data processor of the UE 10, such as the processor 10A shown, or by hardware, or by a combination of software and hardware. Further in this regard it should be noted that the various logical step descriptions above may represent program steps, or interconnected logic circuits, blocks and functions, or a combination of program steps and logic circuits, blocks and functions.

In general, the various embodiments may be implemented in hardware or special purpose circuits, software (computer readable instructions embodied on a computer readable medium), logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

Various modifications and adaptations may become apparent to those skilled in the relevant arts in view of the foregoing description, when read in conjunction with the accompanying drawings. However, any and all modifications of the teachings of this invention will still fall within the scope of the non-limiting embodiments of this invention.

Although described in the context of particular embodiments, it will be apparent to those skilled in the art that a number of modifications and various changes to these teachings may occur. Thus, while the invention has been particularly shown and described with respect to one or more embodiments thereof, it will be understood by those skilled in the art that certain modifications or changes may be made therein without departing from the scope of the invention as set forth above, or from the scope of the ensuing claims.

1. A method comprising:
storing a pre-determined grouping of a plurality of downlink subframes that map to one uplink subframe for at least one instance of when a number of downlink subframes exceeds a number of uplink subframes in a frame;
scheduling a series of downlink and uplink subframes in a frame corresponding to one of the at least one instance and generating a signal that is to be transmitted, the signal that is to be transmitted comprising scheduling grants to user equipments in at least some of the scheduled downlink subframes, wherein the number of scheduled downlink subframes is greater than the number of scheduled uplink subframes in the frame;
receiving acknowledgements from the user equipments to which the scheduling grants were sent, wherein multiple ones of the acknowledgements are received in a single uplink subframe; and
mapping all of the multiple acknowledgements received in the single uplink subframe to the downlink subframes of the group that maps to the single uplink subframe according to the predetermined grouping for the corresponding instance.

2. The method of claim 1, further comprising mapping each of the acknowledgements received in the single uplink subframe to an individual downlink subframe of the corresponding group according to which physical resource block within the single subframe the acknowledgement was received.

3. The method of claim 1, executed by a node B that schedules the downlink and uplink subframes according to a time division duplex mode of an evolved universal mobile telecommunications system terrestrial radio access network.

4. The method of claim 1, wherein for each of the at least one instance that has two uplink subframes, each of the two uplink subframes maps to a different group of downlink subframes.

5. A memory embodying a program of machine readable instructions executable by a processor to perform actions directed to mapping acknowledgement messages, the actions comprising:
storing a pre-determined grouping of a plurality of downlink subframes that map to one uplink subframe for each of at least one instance of when a number of downlink subframes exceeds a number of uplink subframes in a frame;
scheduling a series of downlink and uplink subframes in a frame corresponding to one of the at least one instance and generating a signal that is to be transmitted, the signal that is to be transmitted comprising scheduling grants to user equipments in at least some of the scheduled downlink subframes, wherein the number of scheduled downlink subframes is greater than the number of scheduled uplink subframes in the frame;
receiving acknowledgements from the user equipments to which the scheduling grants were sent, wherein multiple ones of the acknowledgements are received in a single uplink subframe; and
mapping all of the multiple acknowledgements received in the single uplink subframe to the downlink subframes of the group that maps to the single uplink subframe according to the predetermined grouping for the corresponding instance.

6. The memory of claim 5, the actions further comprising mapping each of the acknowledgements received in the single uplink subframe to an individual downlink subframe of the corresponding group according to which physical resource block within the single subframe the acknowledgement was received.

7. The memory of claim 5, wherein for each of the at least one instance that has two uplink subframes, each of the two uplink subframes maps to a different group of downlink subframes.

8. An apparatus comprising:
a memory storing a pre-determined grouping of a plurality of downlink subframes that map to one uplink subframe for one instance of when a number of downlink subframes exceeds a number of uplink subframes in a frame;
a scheduler configured to schedule a series of downlink and uplink subframes in a frame corresponding to one of the at least one instance, wherein the number of scheduled downlink subframes is greater than the number of scheduled uplink subframes in the frame;
a transmitter configured to generate a signal that is to be transmitted, the signal that is to be transmitted comprising scheduling grants to user equipments in at least some of the scheduled downlink subframes;
a receiver configured to receive acknowledgements from the user equipments to which the scheduling grants were sent, wherein multiple ones of the acknowledgements are received in a single uplink subframe; and
a processor configured to map all of the multiple acknowledgements received in the single uplink subframe to the downlink subframes of the group that maps to the single uplink subframe according to the predetermined grouping for the corresponding instance.

9. The apparatus of claim 8, wherein the processor is further configured to map each of the acknowledgements received in the single uplink subframe to an individual downlink subframe of the corresponding group according to which physical resource block within the single subframe the acknowledgement was received.

10. The apparatus of claim 8, wherein the apparatus comprises a node B of an evolved universal mobile telecommunications system terrestrial radio access network and the series of downlink and uplink subframes are scheduled according to a time division duplex mode.

11. The apparatus of claim 8, wherein for each of the at least one instance that has two uplink subframes, each of the two uplink subframes maps to a different group of downlink subframes.

12. A method comprising:
storing a pre-determined grouping of a plurality of downlink subframes that map to one uplink subframe for each of at least one instance of when a number of downlink subframes exceeds a number of uplink subframes in a frame;
receiving a scheduling grant in a downlink subframe of a frame for which the number of scheduled downlink subframes is greater than the number of scheduled uplink subframes in the frame;
using the stored predetermined grouping for the instance that corresponds to the frame in which the scheduling grant was received to map the downlink subframe in which the scheduling grant was received to an uplink subframe; and
generating a signal that is to be transmitted in the mapped uplink subframe, the signal that is to be transmitted comprising an acknowledgement for the received scheduling grant.

13. The method of claim 12, further comprising mapping the downlink subframe in which the scheduling grant was received to an individual physical resource block in the uplink subframe, and wherein sending the acknowledgement comprises sending the acknowledgement in the mapped physical resource block within the uplink subframe.

14. The method of claim 12, executed by a user equipment operating in an evolved universal mobile telecommunications system terrestrial radio access network, and wherein the scheduling grant is received according to a time division duplex mode.

15. The method of claim 12, wherein for each of the at least one instance that has two uplink subframes, each of the two uplink subframes maps to a different group of downlink subframes.

16. A memory embodying a program of machine readable instructions executable by a processor to perform actions directed to mapping a scheduling grant, the actions comprising:
storing a pre-determined grouping of a plurality of downlink subframes that map to one uplink subframe for each of at least one instance of when a number of downlink subframes exceeds a number of uplink subframes in a frame;
receiving a scheduling grant in a downlink subframe of a frame for which the number of scheduled downlink subframes is greater than the number of scheduled uplink subframes in the frame;
using the stored predetermined grouping for the instance that corresponds to the frame in which the scheduling grant was received to map the downlink subframe in which the scheduling grant was received to an uplink subframe; and
generating a signal that is to be transmitted in the mapped uplink subframe, the signal that is to be transmitted comprising an acknowledgement for the received scheduling grant.

17. The memory of claim 16, the actions further comprising mapping the downlink subframe in which the scheduling grant was received to an individual physical resource block in the uplink subframe, and wherein sending the acknowledgement comprises sending the acknowledgement in the mapped physical resource block within the uplink subframe.

18. The memory of claim 16, wherein for each of the at least one instance that has two uplink subframes, each of the two uplink subframes maps to a different group of downlink subframes.

19. An apparatus comprising:
a memory storing a pre-determined grouping of a plurality of downlink subframes that map to one uplink subframe for each of at least one instance of when a number of downlink subframes exceeds a number of uplink subframes in a frame;
a receiver configured to receive a scheduling grant in a downlink subframe of a frame for which the number of scheduled downlink subframes is greater than the number of scheduled uplink subframes in the frame;
a processor configured to use the stored predetermined grouping for the instance that corresponds to the frame in which the scheduling grant was received to map the downlink subframe in which the scheduling grant was received to an uplink subframe, and to generate a signal that is to be transmitted in the mapped uplink subframe, the signal that is to be transmitted comprising an acknowledgement for the received scheduling grant.

20. The apparatus of claim 19, wherein the processor is further configured to map the downlink subframe in which the scheduling grant was received to an individual physical resource block in the uplink subframe, and the apparatus further comprises a transmitter that is configured to send the acknowledgement in the mapped physical resource block within the uplink subframe.

21. The apparatus of claim 19, wherein the apparatus comprises a user equipment operating in an evolved universal mobile telecommunications system terrestrial radio access network, and wherein the scheduling grant is received according to a time division duplex mode.

22. The apparatus of claim 19, wherein for each of the at least one instance that has two uplink subframes, each of the two uplink subframes maps to a different group of downlink subframes.
